(19) United States
(12) Patent Application Publication
(10) Pub. No.: US 2015/0326474 A1
(43) Pub. Date: Nov. 12, 2015

(54) PATH TO HOST IN RESPONSE TO MESSAGE

(71) Applicant: HEWLETT-PACKARD DEVELOPMENT COMPANY, Houston, TX (US)

(72) Inventor: Alvaro Enrique Retana, Raleigh, NC (US)

(21) Appl. No.: 14/648,416

(22) PCT Filed: Nov. 30, 2012
(86) PCT No.: PCT/US2012/067282

§ 371 Date: May 29, 2015

(51) Int. Cl. H04L 12/741; H04W 8/26; H04W 40/24

(52) U.S. Cl. CPC H04L 45/54; H04W 40/248; H04W 8/26

(57) ABSTRACT

Embodiments herein relate to including or removing a path to a host at a data center based on messages transmitted by the host. The host transmits a first message to the data center (DC) if the host joins the DC, the first message to indicate a presence of the host. The DC updates a routing table to indicate a path to the host, based on the first message. A second message is transmitted if the host leaves the DC. The DC updates the routing table to remove the path to the host, based on the second message.

### BACKGROUND

Data centers provide various services to clients. When a service is mobile, and thus transferable between a plurality of data centers, inefficiencies, delays and/or errors in providing the service to the client may result. Service providers are challenged to provide more efficient incoming routes to mobile services at data centers.

### BRIEF DESCRIPTION OF THE DRAWINGS

The following detailed description references the drawings, wherein:

FIG. 1A is an example block diagram of a host joining a data center and FIG. 1B is an example block diagram of the host to leave the data center;

FIG. 2 is another example block diagram of a host to leave a first data center interconnected to a second data center;

FIG. 3 is an example block diagram of a computing device including instructions for transmitting messages from a host leaving or joining a data center; and

FIG. 4 is an example flowchart of a method for adding and removing a path to a host at a data center.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Data centers (DC) provide various services to clients. These services may be implemented via hosts. In interconnected DCs, the hosts may be moved from one of the DCs to another of the DCs. A host maintains the same Internet Protocol (IP) address, regardless of the DC in which the host is located. However, if the data centers do not recognize the new location of the moved host, Internet Protocol (IP) routing to the moved host may be sub-optimal. For example, when a client seeks to access the moved host, only the previous DC, which no longer includes the moved host, may incorrectly advertise a route to the host. In this case, the route to the host may enter through the previous DC and then flow to a current DC, which holds the moved host, via an interconnect. Thus, as the route does not directly flow to the current DC, this route may be inefficient or asymmetrical.

In another scenario, because route advertisements at an edge of the DCs may be static, both the previous and current DCs may respond with route advertisements to the host. In case, there may be confusion as to which of the DCs actually includes the moved host. In yet another scenario, no DCs may respond with route advertisements, if the previous DC is aware the host has moved but the current DC is not yet aware of the moved host. Traditional methods may use an additional layer or interface between the client and DCs to address this issue or continuously poll the hosts. However, such methods are undesirable as they require the DCs to be closely integrated with an additional mobility management system or are highly resource intensive.

Embodiments may provide a method and/or device for dynamic route advertisement based on a current presence of a mobile host that is event driven and network based. For example, a host may transmit a first message to the data center (DC) if the host joins the DC, the first message to indicate a presence of the host. The DC updates a routing table to indicate a path to the host, based on the first message. A second message is transmitted if the host leaves the DC. The DC updates the routing table to remove the path to the host, based on the second message. Thus, embodiments do not require the DC to closely integrate with an additional controller, such as a mobility management system, nor do embodiments poll the host.

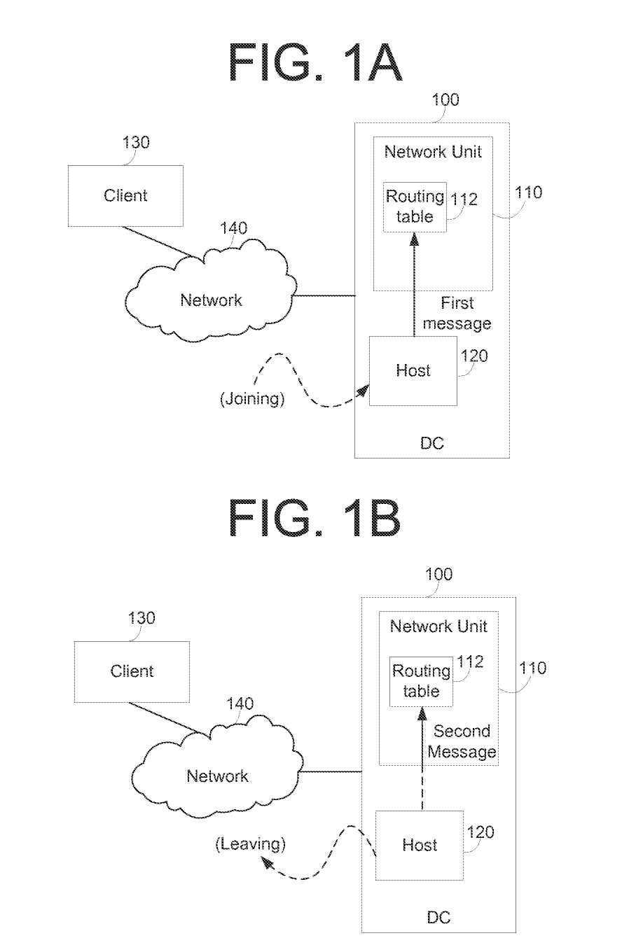

Referring now to the drawings, FIG. 1A is an example block diagram of a host 120 joining a data center (DC) 100 and FIG. 1B is an example block diagram of the host 120 to leave the data center 100. The DC 100 may be any type of facility used to house computer systems and associated components, such as telecommunications and storage systems. The DC 100 is shown to include a network unit 110 and a host 120. Further, the DC 100 is shown to interface with a client 130 via a network 140.

The host 120 and the client 130 may be part of a client-server architecture, where the client 130 may request a service from the host 120. For example, the host 120 may run at least part of an operating system (OS) and/or application of the client 130. Embodiments of the client 130 may include, for example, a workstation, terminal, mobile computer, desktop computer, thin client, and the like.

The host 120 may be a physical computing device running software and/or a virtualized computing device to provide a resource or service to a service requester, such as the client 130. Examples of the host 120 may include a server, a virtual host, a virtual machine (VM), and the like. The host 120 may include a processor (not shown) and a machine-readable storage medium (not shown), if the host 120 is the physical computing device. The processor may be, at least one central processing unit (CPU), at least one semiconductor-based microprocessor, at least one graphics processing unit (GPU), other hardware devices suitable for retrieval and execution of instructions stored in the machine-readable storage medium. The machine-readable storage medium may be any electronic, magnetic, optical, or other physical storage device that contains or stores executable instructions.

The host 120 may also relate to being a method for hosting multiple domain names (with separate handling of each name) on a single server (or pool of servers), if the host 120 is a virtual host. Further, the host 120 may be a simulation of a machine (abstract or real) that is usually different from a target machine that it is being simulated on, if the host 120 is a virtual machine (VM).

Although not shown, the network unit 110 may include various types of devices that processes packets of data, such as layer 3 (L3) switches, layer 2 (L2) switches, routers, hubs, bridges, hubs, high-speed cables, and the like. Here, the network unit 110 is shown to include a routing table 112, which may be a data table stored in a router or a networked computer that lists the routes to particular network destinations, such as the host 120. For example, the routing table 112 may correlate a Internet Protocol (IP) address with a port number and/or Media Access Control (MAC) number.

In FIG. 1A, the host 120 transmits a first message to the network unit 110 in response to joining the network unit 110. The first message indicates a presence of the host 120 to the DC 100. For instance, the host 120 may be have just been created at the DC 100 or migrated to the DC 100 from another location. In one instance, the first message may include a gratuitous Address Resolution Protocol (ARP) packet, which includes the IP address of the host 120. Upon receiving the first message, the network unit 110 may update the routing table 112 to include a path to the host 120. For example, one or more routing tables of routers (not shown) may be updated to correlate a port number and/or MAC address with the IP address of the host 120, in response to the first message.

As shown in FIG. 1B, at a later time, the host 120 may leave the DC 100, such as if the host 120 is terminated or migrates to another DC. In this case, the host 120 and/or the network unit 110 is to trigger a second message. Thus, the second message is event driven, and no polling is carried out by the DC 100. The network unit 110 is to update the routing table 112 to remove the path to the host 120 in response to the second message. For example, one or more routing tables of routers may be updated to remove the correlation between the port number and/or MAC address with the IP address of the host 120.

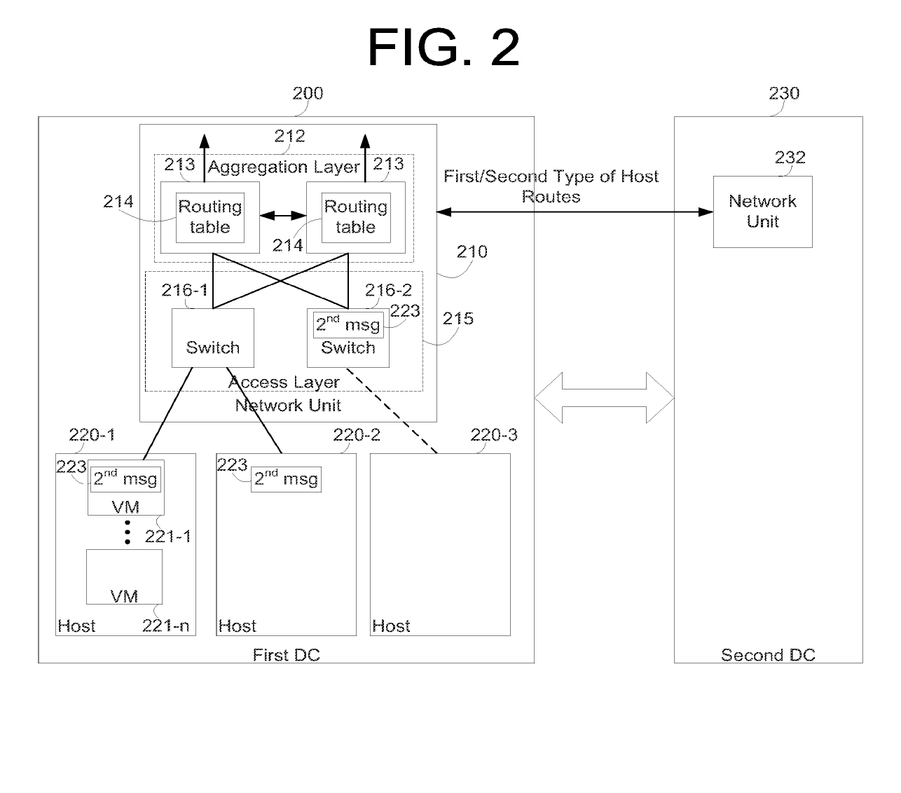

An example of the second message may include a Link Layer Discovery Protocol-Media Endpoint Discovery (LLDP-MED) type-length-value (TLV) structure. The LLPD-MED TLV may include a Media Access Control (MAC) address no longer available to the DC, such as that of the host 120. The dotted line between the host 120 and the network 110 indicates that the second message may be generated by the host 120 in some embodiments, while other embodiments may generate the second message within the network unit 110 itself. The second message will be explained in greater detail with respect to FIG. 2.

FIG. 2 is another example block diagram of a host 220 to leave a first DC 220 interconnected to a second DC 230. The first and second DCs 220 and 230 may be any type of facility used to house computer systems and associated components, such as telecommunications and storage systems. Here, the first and second DCs 220 and 230 are shown to be interconnected, such as via an L2 or L3 extension. The interconnect between DCs may provide flexibility for deploying applications and/or resiliency schemes. The host 220 maintains a same internet protocol (IP) address in both the first and second DCs 200 and 230.

In FIG. 2, the first DC 220 is shown include a network unit 210 and plurality of hosts 220-1 to 220-3. The network unit 210 and hosts 220-1 to 220-3 of FIG. 2 may at least respectively include the functionality and/or hardware of the network unit 110 and host 120 of FIG. 1. While the first DC 200 is primarily discussed below, the second DC 230 may include hardware and/or functionality similar to the first DC 200.

As explained above, the second message is generated to indicate that the host 220 is leaving or has left the first DC 200. As a result of the second message, the first DC 200 will update one or more routing tables 213 and cease to advertise a path or route for incoming traffic to the host 220. In FIG. 2, the three hosts 220-1 to 220-3 each illustrate a different way for generating the second message 223. All of the hosts 220-1 to 220-3 are shown to interface with an access layer 215 of the network unit 210. For example, the first and second hosts 220-1 and 220-2 interface with a first switch 216-1 of the access layer 215 and the third host 220-3 interfaces with a second switch 216-2 of the access layer 215. The access layer 215 may generally include L2 devices, such as L2 switches and hubs, that interface with end nodes, such as hosts, computer clusters and the like.

The access layer 215 further interfaces with an aggregation layer 212, which may include L3 devices, such as LAN-based routers and L3 switches. The aggregation layer 212 may ensure that packets are properly routed between subnets and VLANs. Here, the aggregation layer 212 is shown to include two routers 213 each having a routing table 214. The network unit 210 may also include a core layer (not shown), which may include the backbone of a network, such as high-end switches and high-speed cables. The core layer may be concerned with speed and reliable delivery of packets.

The first host 220-1 is shown to host a plurality of VMs 221-1 to 221-n, where n is a natural number. In this instance, the first VM 221-2 generates the second message 223 before leaving the first host 221-1, where the first host 221-1 forwards the second message 223 to the network unit 210. The second host 220-2 is shown to generate the second message 223 itself, regardless of whether the second host 220-2 includes a VM 221. While the first and second hosts 220-1 and 220-2 are shown to include functionality for generating the second message before the VM 221 and/or host 220 leaves the first DC 200, the third host 220-3 lacks such functionality. In this case, the third host 220-3 leaves the first DC 200 without generating the second message 223. However, the second switch 216-2 may detect a broken link after the third host 220-3 leaves, and then the second switch 216-2 itself may generate the second message 223. The second messages 223 may be forwarded along until a L3 device having a routing table is reached, such as the routers 213 at the aggregation layer 212.

The first and second hosts 220-1 and 220-2 and the second switch 216-2 may include, for example, a hardware device including electronic circuitry for generating the second message 223, such as control logic and/or memory. In addition or as an alternative, the first and second hosts 220-1 and 220-2 and the second switch 216-2 may be implemented as a series of instructions encoded on a machine-readable storage medium and executable by a processor. While embodiments show the aggregation layer 212 having L3 devices and the access layer 215 having L2 devices, L2 and L3 devices may be found in any combination in the aggregation and access layers 212 and 215. Further, embodiments may include more or less hosts, switches and/or routers than that shown in the first DC 200.

When there are a plurality of hosts 220, especially a large number of hosts 220, a great number of first and/or second messages may be generated. In order to reduce strain to bandwidth and/or memory resources, communication related to updating routing tables 214 may be compacted and/or summarized. For example, a plurality of the first messages may be generated by the plurality of hosts 220-1 to 220-3, if the plurality of hosts 220-1 to 220-3 are joining the network unit 210. Assuming the three hosts 220-1 to 220-3 and/or VMs 221 thereof have contiguous IP addresses, the network unit 210 may generate a first type of host route including a partially masked IP address that covers a range of contiguous IP addresses, including the IP addresses of the hosts 220-1 to 220-3.

As a result, lesser addresses and/or shorter addresses may be transmitted throughout the network unit 210 than if each of the individual IP address was submitted. For example, if there are 8 contiguous IP address, a single IP address that has last 3 bits masked may be transmitted instead. The first type of host route may indicate IP addresses to be added to the routing tables 214. However, in some embodiments of the first type of host route, a range of contiguous IP addresses may be covered, where at least one of the contiguous addresses is not assigned to an actual host 220. Such incorrect address summaries may then be corrected afterward, if necessary, with a subsequent first type of host route including the specific IP address(es) not assigned to any of the hosts 220.

Further, a plurality of the second messages may be generated by at least one of the plurality of hosts 220-1 to 220-3 and/or the network unit itself 212, if the plurality of hosts 220-1 to 220-3 are leaving the first DC 200. Assuming the three hosts 220-1 to 220-3 and/or VMs 221 thereof have contiguous IP addresses, the network unit 210 may generate a second type of host route including a partially masked IP address that covers a range of contiguous IP addresses, including the IP addresses of the hosts 220-1 to 220-3. This truncation may be similar to truncation for the first type of host route. However, the second type of host route may indicate the IP addresses to be removed to the routing tables 214. Similar to above, in some embodiments of the second type of host route, a range of contiguous IP addresses may be covered, where at least one of the contiguous addresses belongs to a host 220 that is remaining in the first DC 200. Such incorrect address summaries may then be corrected afterward, if necessary, with a subsequent second type of host route including the specific IP address(es) of the hosts 220 not leaving the first DC 200.

An amount of truncation or masking as well as an amount of incorrect address summaries allowed for the first and second types of host routes may be based on policy considerations. For example, an embodiment may include a length threshold indicating a minimum length for the masked IP address and/or a percentage threshold indicating a minimum percentage of the affected hosts to be included in the masked IP address.

The subsequent first and second types of host routes may be triggered by first and second messages and/or communication between the switches 216 and/or routers 214. For example, the network unit 210 of the first DC 200 may exchange routing information with a network unit 232 of the second DC 230. As a result, routing information may be coordinated between the two DCs 200 and 230 and less routing information may be have transmitted within at least one of the DCs 200 and 230. For example, the network unit 210 of the first DC 200 may select content of the first and second type of host routes based on content included in first and second types of host routes of the of the second DC 230. For instance, incorrect entries in routing tables 213 due incorrect address summaries included in the first and second type of host routes, may be corrected by cross-talk between the routers 213 and 232. Moreover, it may be determined that is possible for even more information to be summarized or excluded in the first and/or second type of host routes based on the cross-talk.

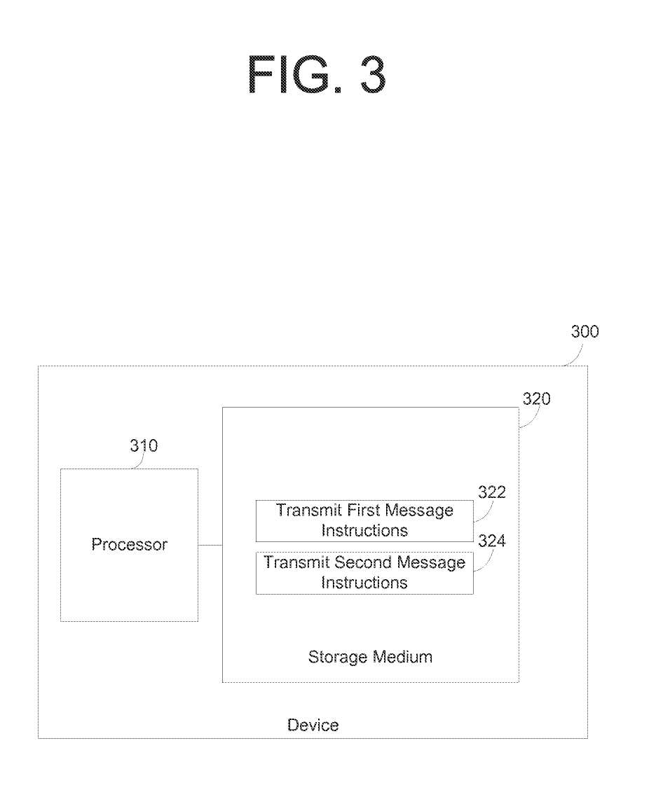

FIG. 3 is an example block diagram of a computing device 300 including instructions for transmitting messages from a host leaving or joining a data center. In the embodiment of FIG. 3, the computing device 300 includes a processor 310 and a machine-readable storage medium 320. The machine-readable storage medium 320 further includes instructions 322 and 324 for transmitting messages from a host leaving or joining a data center. The computing device 300 may be, for example, a router, a switch, a gateway, a bridge, a server or any other type of device capable of executing the instructions 322 and 324. In certain examples, the computing device 400 may be included or be connected to additional components such as a storage drive, a processor, a network element, etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322 and 324 to implement transmitting messages from a host leaving or joining a data center. As an alternative or in addition to retrieving and executing instructions, the processor 310 may include at least one integrated circuit (IC), other control logic, other electronic circuits, or combinations thereof that include a number of electronic components for performing the functionality of instructions 322 and 324.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for forwarding an instruction based on the predication criteria.

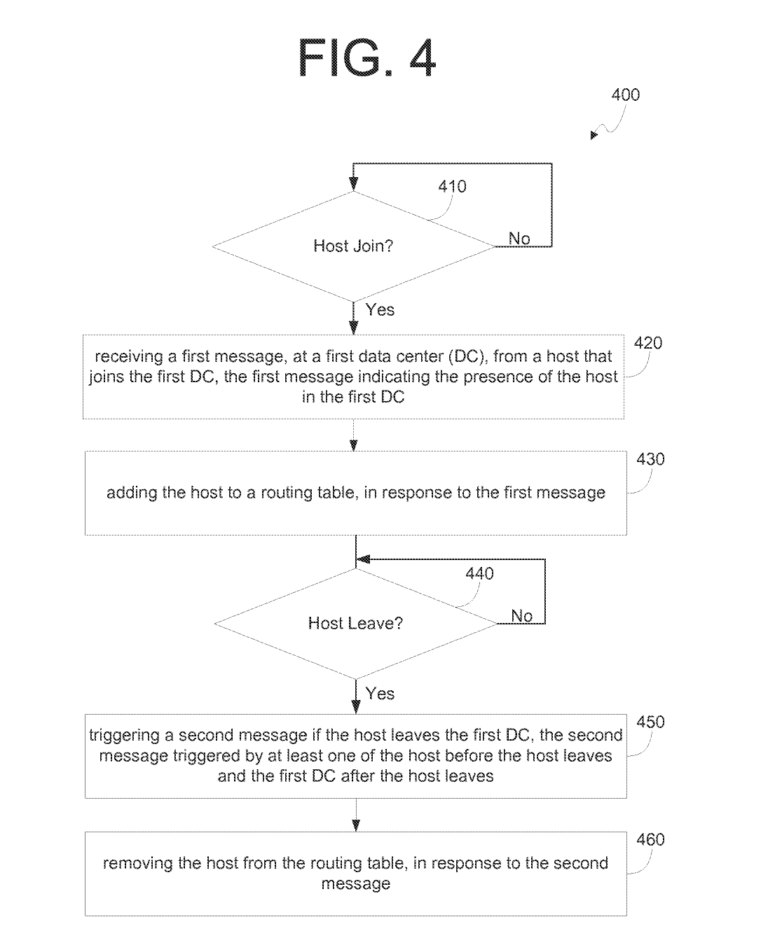

Moreover, the instructions 322 and 324 when executed by a processor (e.g., via one processing element or multiple processing elements of the processor) can cause the processor to perform processes, such as, the process of FIG. 4. For example, the transmit first message instructions 322 may be executed by the processor 310 to transmit a first message to a DC (not shown) if a host (not shown) joins the DC. The first message is to indicate a presence of the host to the DC, with the DC to update a routing table (not shown) to indicate a path to the host, based on the first message. The transmit second message instructions 324 may be executed by the processor 310 to transmit a second message to the DC if the host is to leave the DC. The DC is to update the routing table to remove the path to the host, based on the second message.

An example of the first message may include a gratuitous Address Resolution Protocol (ARP) packet. An example of the second message may include a Link Layer Discovery Protocol-Media Endpoint Discovery (LLDP-MED) type-length-value (TLV) structure. The LLPD-MED TLV to include a Media Access Control (MAC) address no longer available to the DC, such as that of the host.

FIG. 4 is an example flowchart of a method 400 for adding and removing a path to a host at a DC. Although execution of the method 400 is described below with reference to the first DC 200, other suitable components for execution of the method 500 can be utilized, such as the first DC 100 or the second DC 230. Additionally, the components for executing the method 400 may be spread among multiple devices. The method 400 may be implemented in the form of executable instructions stored on a machine-readable storage medium, such as storage medium 320, and/or in the form of electronic circuitry.

At block 410, if a host 220 joins a first DC 200, the host 220 transmits a first message. Next a block 420, the first DC 200 receives the first message. The first message indicates the presence of the host 220 in the first DC 200. Next, at block 430, the first DC 200 adds a path to the host 220 to a routing table 214, in response to the first message. Then, at block 440, if the host 220 leaves or is to leave the first DC 200, the method 400 flows to block 450, where a second message is triggered. The second message may be triggered by the host 220 itself before the host 220 leaves or the first DC 200 after the host 220 leaves.

For example, the host 220 may transmit the second message before leaving or the first DC 200 may detect that the host 220 has left and then generate the second message. In one instance first DC 200 may detect that the host 220 has left if a switch 216 of the first DC 200 detects a broken link between the host 220 and the first DC 200. Lastly, at block 460, the first DC 200 removes the path to the host 220 from the routing table 214, in response to the second message. The host 220 may be a server or virtual machine (VM) hosted by the host 220. The first DC 200 may include a switch and/or router. The host 220 may have left a second DC 230 before joining the first DC 220, where the first DC 200 is interconnected to the second DC 230, such as via a layer 2 (L2) extension. The host 220 maintains a same IP address in both the first and second DCs 200 and 230.

According to the foregoing, embodiments may provide a method and/or device for dynamic route advertisement based on a current presence of a mobile host that is event driven and network based. For example, a host may transmit a first message to the data center (DC) if the host joins the DC, the first message to indicate a presence of the host. The DC updates a routing table to indicate a path to the host, based on the first message. A second message is transmitted if the host leaves the DC. The DC updates the routing table to remove the path to the host, based on the second message. Thus, embodiments do not require the DC to closely integrate with an additional controller, such as a mobility management system, nor do embodiments poll the host.

We claim:

1. A first data center (DC), comprising:
a network unit including a routing table; and
a host to transmit a first message to the network unit in response to joining the network unit, the first message to indicate a presence of the host, wherein
the network unit is to update the routing table to include a path to the host in response to the first message,
at least one of the host and the network unit is to trigger a second message if the host leaves the network unit, and
the network unit to update the routing table to remove the path to the host in response to the second message.

2. The first DC of claim 1, wherein the second message is generated by at least one of,
the host before the host leaves the first data DC,
a virtual machine (VM) on the host before the VM leaves the host, and
the network unit after the network unit detects a broken link between the host and the network unit.

3. The first DC of claim 2, wherein,
a plurality of the first messages are generated by a plurality of network elements, if the plurality of network elements are joining the network unit,
a plurality of the second messages are generated by at least one of the plurality of network elements and the network unit, if the plurality of network elements are leaving the network unit, and
each of the plurality of network elements corresponds to one of a host and a virtual machine (VM) hosted on a host.

4. The first DC of claim 3, wherein,
the network unit generates a first type of host route with a partially masked address to group a plurality of contiguous addresses to be added to the routing table, if the plurality of first messages are generated, and
the network unit generates a second type of host route with a partially masked address to group a plurality of contiguous addresses to be removed from the routing table, if the plurality of second messages are generated.

5. The first DC of claim 4, wherein,
at least one of the contiguous addresses of the first type of host route is not assigned to any of the network elements, and
at least one of the contiguous addresses of the second type of host route belongs to a network element that is not leaving the network unit.

6. The first DC of claim 4, wherein the partially masked address of the first and second types of host routes is generated based on at least one of a length threshold for an address and a percentage threshold indicating a minimum percentage of the affected network elements to be covered by the masked address.

7. The first DC of claim 4, wherein,
the first DC is interconnected to a second DC;
the network unit of the first DC is to exchange routing information with a network unit of the second DC, and
the network unit of the first DC is to select content of the first and second type of host routes based on content included in first and second types of host routes of the of the second DC.

8. The first DC of claim 1, wherein,
network unit further includes a switch and a router, the switch to interface between the router and the host and router to include the routing table,
the switch is included in an access layer of the network unit, and
the router is included in an aggregation layer of the network unit.

9. The first DC of claim 1, wherein,
the first DC is interconnected to a second DC,
the host maintains a same internet protocol (IP) address when migrating from one of the first and second DCs to an other of the first and second DCs, and
the first message includes an Internet Protocol (IP) address of the host.

10. The first DC of claim 1, wherein,
the second message includes a Link Layer Discovery Protocol-Media Endpoint Discovery (LLDP-MED) type-length-value (TLV) structure to indicate a departure of the host, and
the LLPD-MED TLV includes one or more Media Access Control (MAC) addresses no longer available to the first DC.

11. A method, comprising:
receiving a first message, at a first data center (DC), from a host that joins the first DC, the first message indicating the presence of the host in the first DC;
adding a path to the host to a routing table, in response to the first message;
triggering a second message if the host leaves the first DC, the second message triggered by at least one of the host before the host leaves and the first DC after the host leaves; and
removing the path to the host from the routing table, in response to the second message.

12. The method of claim 11, wherein
the host is at least one of a server and virtual machine hosted by the host,
the first DC includes a switch, and
the triggering further includes the switch detecting a broken link between the host and the first DC, if the first DC triggers the second message.

13. The method of claim 11, wherein,
the host is to migrate from a second DC to join the first DC,
the first DC is interconnected to a second DC, and
the host maintains a same internet protocol (IP) address in the first and second DCs.

14. A non-transitory computer-readable storage medium storing instructions that, if executed by a processor of a device, cause the processor to:
transmit a first message to a data center (DC) if a host joins the DC, the first message to indicate a presence of the host to the DC, the DC to update a routing table to indicate a path to the host, based on the first message; and
transmit a second message to the DC if the host is to leave the DC, the DC to update the routing table to remove the path to the host, based on the second message.

15. The non-transitory computer-readable storage medium of claim 14, wherein,
the first message includes a gratuitous Address Resolution Protocol (ARP) packet, and
the second message includes a Link Layer Discovery Protocol-Media Endpoint Discovery (LLDP-MED) type-length-value (TLV) structure, the LLPD-MED TLV to include a Media Access Control (MAC) address no longer available to the DC.
